(19) United States
(12) Patent Application Publication
(10) Pub. No.: US 2005/0171882 A1
(43) Pub. Date: Aug. 4, 2005

(54) System and method for making private equity commitments

(76) Inventor: Daniel Nevins, Wayne, PA (US)

Correspondence Address: Daniel H. Golub;Morgan, Lewis & Bockius, LLP, 1701 Market Street, Philadelphia, PA, 19103-2921, US

(21) Appl. No.: 10/768,393

(22) Filed: Jan. 30, 2004

(51) Int. Cl. G06F 17/60

(52) U.S. Cl. 705/36; 705/35

(57) ABSTRACT

A system and method for committing capital to a private equity portion of an investment portfolio that includes the private equity portion and a liquid portion. A committed capital target is determined based on an expected rate of return of the liquid portion, an expected rate of return of the private equity portion, an expected rate at which distributions are paid from the private equity portion, and an expected rate at which capital commitments associated with the private equity portion are invested. The actual value of committed capital in the private equity portion is compared to the committed capital target. Commitment of further capital in the private equity portion is delayed if the actual value of committed capital in the private equity portion exceeds the committed capital target. Further capital in the private equity portion is committed if the actual value of committed capital in the private equity portion is below the committed capital target.

### FIELD OF THE INVENTION

The present invention relates generally to strategies for committing capital to the private equity portion of an investment portfolio.

### BACKGROUND OF THE INVENTION

Unlike the public markets, capital invested in private equity is not equal to the investor's commitments to private equity. The unpredictable timing of capital calls and distributions of cash or stock complicate the relationship between investments and commitments. As a result, investors often find it difficult to achieve and maintain an asset allocation target.

Among the decisions faced by private equity investors are the questions of how much capital to commit to the asset class and when to make additional commitments. These decisions should be determined by the investor's asset allocation policy and, in particular, the desired allocation to private equity. However, unlike the public markets, achieving and maintaining an asset allocation target for private equity is not a simple task.

Private equity has three characteristics that complicate the implementation of an asset allocation target. First, investors do not know when commitments to the asset class will be invested. Investors must be prepared to respond to capital calls at any time during the investment period, which typically extends from one to five years. At the end of the period, invested capital may have fallen significantly short of the amount committed. Second, investors do not know when capital will be returned in the form of distributions. The allocation to the asset class can drop significantly when distributions are large. Conversely, the allocation can rise unexpectedly if capital is retained within the investment vehicle for longer than anticipated. Third, historical data shows that private equity performance has reached extremes not experienced in most other asset classes, implying that the future value of invested capital can be difficult to predict.

The present invention provides a novel, systematic approach for making private equity commitments that addresses the unique complications associated with committing capital to private equity.

### SUMMARY OF THE INVENTION

The present invention manages private equity commitments in a way that directly links these decisions to the investor's asset allocation policy. In one embodiment, targets are established for both invested capital and committed capital in the private equity portion of an investor's portfolio. Invested capital represents the true exposure to private equity and its target is determined first, within the overall asset allocation process. Committed capital is defined as the market value of invested capital plus commitments that have yet to be invested. In one embodiment, the committed capital target is determined using a formula that maximizes the probability of reaching the invested capital target. The formula links the committed capital target to, among other things, an expected rate of return of the liquid portion of an investor's portfolio, an expected rate of return of the private equity portion of the portfolio, an expected rate at which distributions are paid from the private equity portion of the portfolio, and an expected rate at which capital commitments associated with the private equity portion of the portfolio are invested.

Once the committed capital target is calculated, decisions regarding new commitments are made systematically. Investors make new commitments when committed capital falls short of its target. New commitments are delayed when committed capital exceeds its target. The target requires regular monitoring, which ensures that future commitments reflect past performance.

As described below, the commitment strategies of the present invention were evaluated using Monte-Carlo simulations. Commitment strategies were evaluated according to several criteria, including the standard deviation of the invested capital allocation. The standard deviation when using the commitment strategy of the present invention is 1.8%, comparing favorably to 2.8% for a popular alternative approach. Simulations also show invested capital converging to its target more quickly when using the commitment methodology of the present invention.

Investors using the commitment strategies of the present invention reduce the guesswork involved in the commitment decision. They also increase the likelihood of achieving the allocation target for invested capital and ensure that future commitments are adjusted according to past experience.

### BRIEF DESCRIPTION OF THE FIGURES

FIG. 1 is a graph showing annual investments and distributions by fund age for a sample of liquidated funds used for modeling cash flows for an ongoing investment in private equity, in accordance with the present invention.

FIG. 2 is a graph showing cumulative annual investments, distributions, and net asset value by fund age for a sample of liquidated funds used for modeling cash flows for an ongoing investment in private equity, in accordance with the present invention.

FIG. 3 is a graph showing projected annual private equity commitments in a deterministic simulation used to test the private equity commitment methodology of the present invention.

FIG. 4 is a graph showing projected annual private equity allocations in a deterministic simulation used to test the private equity commitment methodology of the present invention.

FIG. 5 is a graph showing the projected distribution of private equity allocation in a stochastic analysis used to test the private equity commitment methodology of the present invention.

FIG. 6 is a graph showing a range of private equity allocations under various risk experiences, in accordance with the present invention.

FIG. 7 is a graph showing a range of private equity allocations under various correlation experiences, in accordance with the present invention.

FIG. 8 is a graph showing a range of private equity allocations under various return experiences, in accordance with the present invention.

FIG. 9 is a graph showing the projected distribution of private equity allocations using a constant 5% annual commitment strategy.

FIG. 10 is a graph showing the projected distribution of private equity allocations using a constant annual commitment strategy, calibrated so that the median allocation converges to the target.

### DETAILED DESCRIPTION OF THE PREFERRED EMBODIMENT

In view of the unique characteristics of private equity, decisions regarding the amount and timing of capital commitments are challenging. The present invention provides an approach for managing private equity capital commitments that directly links these decisions to an investor's asset allocation target for the private equity portion of the investor's portfolio. The approach provided by the present invention is designed to minimize the differences between the target private equity allocation and the observed allocation. Furthermore, it provides a mechanism for adjusting future private equity commitments based on past experience.

A detailed description of one embodiment of the present invention is set forth below, and organized as follows. First, a formula is described for determining private equity commitments. The formula is based on an investor's asset allocation target, the expected returns for public and private markets, and the expected pattern of cash flows for a private equity program. In the second section, methods for modeling private equity cash flows and estimating key inputs to the formula are described. In the third section, commitment strategies are tested according to various scenarios for public and private market returns. The approach is also tested using Monte-Carlo simulations and a likely range of results are calculated. The fourth section compares the method of the present invention for determining private equity commitments with other approaches.

A Formula for Private Equity Commitments

The academic literature provides little guidance on how much capital to commit and when to recommit capital to the private equity portion of an investor's portfolio. One article of note by Cardie, Cattanach and Kelley [2000] suggests a rule of thumb for deciding commitments. Specifically, they argue that investors should make a commitment every two years in an amount equal to their asset allocation target, or, every year in an amount equal to half of the asset allocation target. Their recommended approach adds discipline to the process for deciding commitments. Many investors have developed similar rules of thumb. However, these simple rules have two shortcomings. First, they do not provide a mechanism for modifying future commitments based on past performance. Second, there is no theoretical underpinning to ensure that the rule of thumb will result in an appropriate allocation to the asset class.

The present invention provides an approach for setting private equity commitments that addresses both of these shortcomings. In the present invention, a target is specified for the amount of committed capital as a proportion of the total portfolio. In other words, just as an asset allocation strategy consists of targets for invested capital in each asset class, it should also include a target for committed capital in the case of private equity. Committed capital (in the case of private equity) equals the market value of invested capital plus commitments that have yet to be invested. In the present invention, when committed capital in the private equity portion of the investor's portfolio rises above the target, investors should delay further capital commitments in the private equity portion of the investor's portfolio. When committed capital in the private equity portion of the investor's portfolio falls below the target, investors should make new capital commitments in the private equity portion of the investor's portfolio.

In the present invention, the target for committed capital (C*) in the private equity portion of an investor's portfolio is linked to the target for invested capital (I*) in the private equity portion of the portfolio and four input parameters as set forth in equation (1) below:

$${C}^{*} = {I}^{*} [ 1 + ( \frac{1}{{r}_{IN}} ) \times [ ( 1 - {I}^{*} ) \times ( {r}_{L} - {r}_{I} ) + {r}_{DI} ] ] \qquad ( 1 )$$

In equation (1), the expected rate of return on the liquid portion of the investor's total portfolio is r_{L}; the expected rate of return on the investor's illiquid, private equity portfolio is r_{I}; the parameter r_{DI} is the rate at which distributions are paid from the private equity portfolio, expressed as a percent of the market value of the portfolio; and the parameter r_{IN} is the rate at which capital commitments are invested, expressed as a percent of the remaining (not yet invested) commitments.

A derivation for Equation (1) is included in the appendix. The derivation is based on the assumption that the investor has established an allocation target for committed capital and sets commitments according to the target. A second assumption is that capital market expectations are realized in each year. In the public markets, expected returns are realized each year. In the private markets, both returns and cash flows are equal to expectations. When these assumptions are met, the ratio of committed capital to invested capital converges to a stable level captured in Equation (1). The point of convergence is referred to as the steady-state ratio of committed capital to invested capital.

In practice, return expectations are not realized in each year as per the derivation of Equation (1). However, unexpected returns are reflected in the ongoing process of managing committed capital against a target. Past investment performance determines the amount of committed capital as a percentage of the total portfolio. Committed capital is then compared to its target to determine new commitments. Thus, new commitments are adjusted to compensate for past performance.

Equation (1) also provides a theoretical link between the investor's target for commitments and the target for invested capital. The target for invested capital should be set within the overall asset allocation process. Then, once the parameters r_{L}, r_{I}, r_{DI}, and r_{IN} are determined, the target for committed capital can be computed using the equation. In one embodiment, expected returns for the private and public markets, r_{L} and r_{I}, represent long-term expectations. With regard to private equity cash flows, many investors maintain cash flow models that already contain the information required to calculate r_{DI} and r_{IN}. The subject of cash flow modeling is considered below.

Modeling Private Equity Cash Flows

Regardless of the method used to determine commitments, investors should have an understanding of the likely pattern of cash flows for their private equity portfolio. Cash flows depend on a number of factors, including the market environment and the characteristics of funds in which the investor is participating. One approach to modeling cash flows begins with empirical analysis to identify historical cash flow patterns. Then, historical results are adjusted to reflect the investor's qualitative analysis. Consideration of historical relationships provides a valuable test of the assumptions underlying the qualitative analysis.

To demonstrate the use of a committed capital target as discussed in the preceding section, an empirical model for private equity cash flows is used. The model is based on liquidated buyout and venture capital funds in the Venture Economics database for vintage years between 1980 and 2000. There are 283 funds in the sample after applying various filters to remove duplicate records and ensure reasonable cash flow patterns. The analysis is restricted to liquidated funds because they have completed the entire fund lifecycle. Ongoing funds would have complicated the analysis because their cash flows are incomplete.

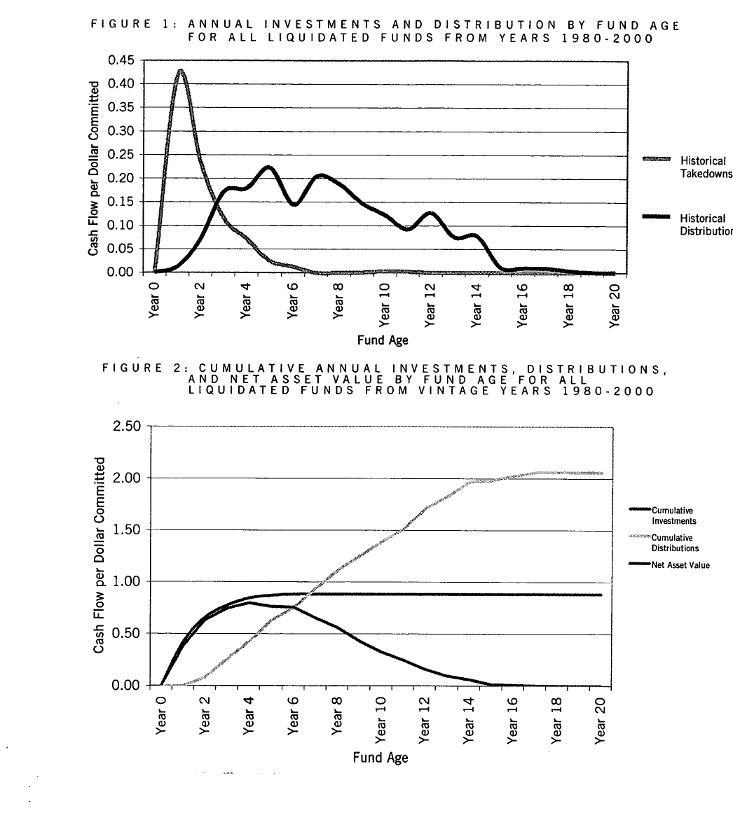

Although the objective is to estimate cash flows for an ongoing investment in private equity, cash flows for a single fund are modeled first. The single fund cash flow model is based on the aggregate of all of the cash flows in the sample of funds. Funds are aggregated on a lifecycle basis rather than a calendar year basis, meaning that the investments and distributions for each fund age are summed, as shown in FIG. 1. Investments and distributions are expressed as a percentage of total committed capital. The net asset value, which represents invested capital, is also aggregated. The aggregate net asset value for each fund age is shown in FIG. 2, together with cumulative amounts for investments and distributions.

By capturing the historical cash flow pattern for a broad cross-section of liquidated funds, the analysis provides a number of insights into the characteristics of private equity. It shows that the typical fund in the sample draws down 88% of total commitments over its life-span, while 65% of commitments are drawn down in the first two years of the fund's life. Distributions level off after year three. The ratio of total distributions to total paid-in capital for the typical fund is 2.4. Net asset value reaches its peak in year four.

These characteristics describe all of the funds in the sample. In practice, investors should contrast the historical analysis with their particular private equity investments. Investors could customize the analysis by aggregating cash flows for specific sectors of the private equity market, then weighting each sector according to their own portfolio weights. For example, for a portfolio with 50% early stage venture capital and 50% large buyouts, the historical data used in the cash flow analysis should be restricted to include only these two sub-styles. Consideration of the existing market environment may also prompt adjustments to the historical cash flows. Particular attention should be given to the internal rate of return implied by the historical data, which could be inconsistent with the investor's expected return on a forward-looking basis. If the historical rate of return is not expected to persist, a scaling factor can be applied to the historical distributions to reflect the forward-looking expected return.

Once inconsistencies between the historical data and the particular portfolio have been addressed, and the single-fund cash flow model is established, the parameters r_{DI} and r_{IN} can be estimated. The parameters r_{DI} and r_{IN} refer to the cash flow characteristics of an ongoing private equity portfolio rather than a single fund. The ongoing portfolio consists of commitments to a series of funds, each fund characterized by the single fund cash flow model. Estimates for r_{DI} and r_{IN} are based on the same assumptions used to derive the committed capital target. First, new commitments are made whenever committed capital falls below its target. Second, capital market expectations are realized each year. As discussed in the Appendix, under these assumptions certain observations about a mature private equity portfolio can be made. First, the growth rates for committed capital, invested capital and total capital converge to the same stable level, denoted g*. Second, the ratio of distributions to invested capital converges to a stable level, denoted r_{DI}*. Third, the ratio of investments to uninvested commitments converges to a stable level, denoted r_{IN}*. The ratios r_{DI}* and r_{IN}*, which are referred to as steady-state ratios, provide estimates for r_{DI} and r_{IN} for use in Equation (1). They are calculated using Equations (2) and (3) below.

$$\begin{matrix}{r}_{DI}^{*} = \frac{{\sum }_{j = 1}^{N} {Distribution}_{j} \times {( 1 + {g}^{*} )}^{j - 1}}{{\sum }_{j = 1}^{N} {NAV}_{j - 1} \times {( 1 + {g}^{*} )}^{j - 1}} & ( 2 ) \\ {r}_{IN}^{*} = \frac{{\sum }_{j = 1}^{N} {Investment}_{j} \times {( 1 + {g}^{*} )}^{j - 1}}{{\sum }_{j = 1}^{N} {UninvestedCommitments}_{j - 1} \times {( 1 + {g}^{*} )}^{j - 1}} & ( 3 )\end{matrix}$$

While r_{DI}* and r_{IN}* describe the characteristics of an ongoing private equity portfolio, the inputs to Equations (2) and (3) are determined by the single-fund cash flow model. Inputs from the single fund cash flow model are summed across N fund ages, with each fund age denoted by j. In other words, the private equity portfolio is diversified across vintage years. The inputs Distributionⱼ, NAVⱼ, and Investmentⱼ were described earlier and illustrated in FIG. 2. The input Uninvested Commitmentsⱼ, also based on the single fund cash flow model, represents the total commitment amount less cumulative investments up to age j. Finally, the portfolio growth rate, g*, determines the relative amount committed to each vintage year. Specifically, each vintage year receives a commitment larger than the previous year's commitment, with the percentage difference equal to g*.

Just as the single fund cash flow model should be consistent with the investor's particular portfolio, r_{DI}* and r_{IN}* should be reconciled with the investor's anticipated cash flows. In some circumstances, it may be appropriate to use other methods for calculating r_{DI} and r_{IN}, rather than relying on Equations (2) and (3). This is most likely to be the case when the investor anticipates significant changes in the private equity portfolio. For example, if investments are currently concentrated in early stage venture capital but the investor plans to implement a new portfolio dominated by buyouts, then the cash flow pattern for the total portfolio is likely to change. In these situations, it may be helpful to model specific components of the portfolio separately, as discussed in Takahashi and Alexander [2002]. Takahashi and Alexander suggest projecting cash flows separately for each fund in which an investor participates. Funds are then aggregated to obtain estimates for cash flows and net asset values for the total portfolio.

Testing the Committed Capital Target

To assess the performance of the approach of the present invention through time and under different market conditions, several simulation tests were conducted. Both deterministic and stochastic simulations were used. In each of the tests, an investor whose asset allocation target for invested capital is 10% was considered. For simplicity it was assumed that the remaining 90% of assets was allocated to the U.S. public equity market. Private equity cash flows were assumed to conform to the historical cash flow model described above and summarized in FIG. 2. Returns, risks, and correlations for the private and public markets were based on the same historical period used to derive the cash flows, 1980 to 2000. These are described in Table 1 below. (The source of Table 1 is Wilshire 5000 for public markets and selected funds from Venture Economics database for private markets (283 liquidated funds weighted 50% venture capital and 50% buyouts)). Sensitivity analysis was also conducted by considering a broad range of alternative assumptions for returns, risks and correlations.

TABLE 1
HISTORICAL PERFORMANCE OF PRIVATE
AND PUBLIC EQUITY MARKETS, 1987-2000.

| | Public | Private |
|---|---|---|
| | Market | Equity |
| Mean Return | 15.6% | 18.2% |
| Standard | 14.6% | 18.9% |
| Deviation | | |
| Correlation | 25% | |

With the assumptions shown in FIG. 2 and Table 1, the targeted committed capital allocation was calculated. Using Equation (2), it was determined that the steady-state ratio for distributions as a percent of invested capital is 26.7%. The steady-state ratio for investments as a percent of uninvested commitments, according to Equation (3), is 50.3%. By applying these inputs to Equation (1), it was found that the targeted allocation for committed capital is 17%.

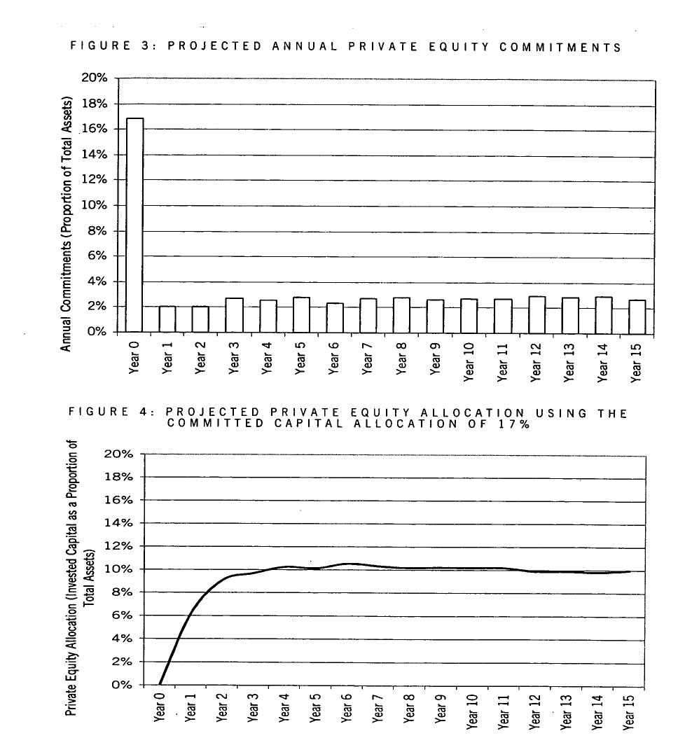

For the deterministic simulation below, a targeted committed capital allocation of 17% was used and it was assumed that cash flows and investment returns evolve according to expectations. The annual commitments from the simulation are shown in FIG. 3. Once the private equity program reaches a stable growth rate, the desired 10% invested capital allocation requires an annual commitment of 2.8% of assets. As shown in FIG. 4, invested capital reaches within 1% of the 10% target by the second year of the simulation, and then converges completely. The allocation initially overshoots its target by 0.5% due to the large commitment to the first vintage year. Diversifying the initial commitment across several vintage years can mitigate overshooting.

A sensitivity analysis with respect to the return assumptions is provided in Table 2 below. Each cell in the table shows the targeted committed capital allocation for a different combination of private and public market returns. The table shows that the targeted committed capital allocation rises when the private equity return falls in relation to the public market return, and visa-versa. When the private and public market returns change by the same amount, there is little effect on the targeted committed capital allocation.

TABLE 2
COMMITTED CAPITAL TARGETS UNDER
VARIOUS PUBLIC AND PRIVATE MARKET RETURN
ASSUMPTIONS.
Public Market Portfolio Return

| | | 0% | 5% | 10% | 15% | 20% | 25% |
|---|---|---|---|---|---|---|---|
| | 0% | 17.1% | 18.0% | 19.0% | 19.9% | 20.9% | 21.9% |
| Private | 5% | 16.2% | 17.1% | 18.1% | 19.0% | 20.0% | 21.0% |
| Market | 10% | 15.5% | 116.3% | 17.2% | 18.1% | 19.1% | 20.1% |
| Port- | 15% | 14.8% | 15.5% | 16.4% | 17.3% | 18.2% | 19.1% |
| folio | | | | | | | |
| Return | 20% | 14.1% | 14.8% | 15.6% | 16.4% | 17.3% | 18.2% |
| | 25% | 13.6% | 14.2% | 14.9% | 15.7% | 16.5% | 17.4% |

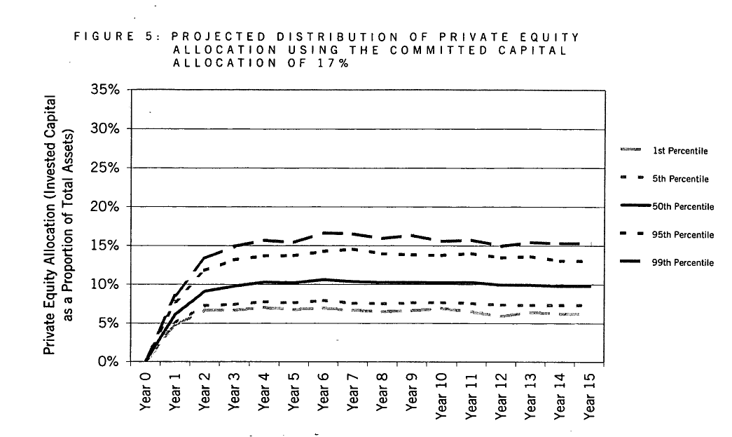

For a stochastic analysis, 1,000 Monte-Carlo simulations were generated assuming that private and public market returns are normally distributed and serially independent. The same 17% committed capital target that was used in the deterministic analysis was applied. The results are shown in FIG. 5. Potential outcomes for the private equity allocation are described using five points or percentiles from the probability distribution. The median (50^{th} percentile) results are approximately the same as the results of the deterministic scenario shown in FIG. 4. The median also converges to the 10% invested capital target. This result reinforces the practical value of the equations used to derive the committed capital target. It shows that the committed capital target has desirable properties even in a Monte-Carlo simulation context, in which return expectations are not realized in each year.

The other percentiles shown in FIG. 5 indicate the dispersion that investors might expect relative to their targeted invested capital allocation. The invested capital allocation drifts from its target when investment returns are unexpectedly high or low. Because private equity positions cannot be readily rebalanced, discrepancies between the observed allocation and the targeted allocation are not immediately corrected. Dispersion relative to the targeted allocation can be described by confidence intervals. The 5^{th} and 95^{th} percentiles in FIG. 5 describe a 90% confidence interval for the invested capital allocation. The 1^{st} and 99^{th} percentiles describe a 98% confidence interval. The chart shows that the amount of dispersion remains relatively constant after the private equity portfolio reaches its third year.

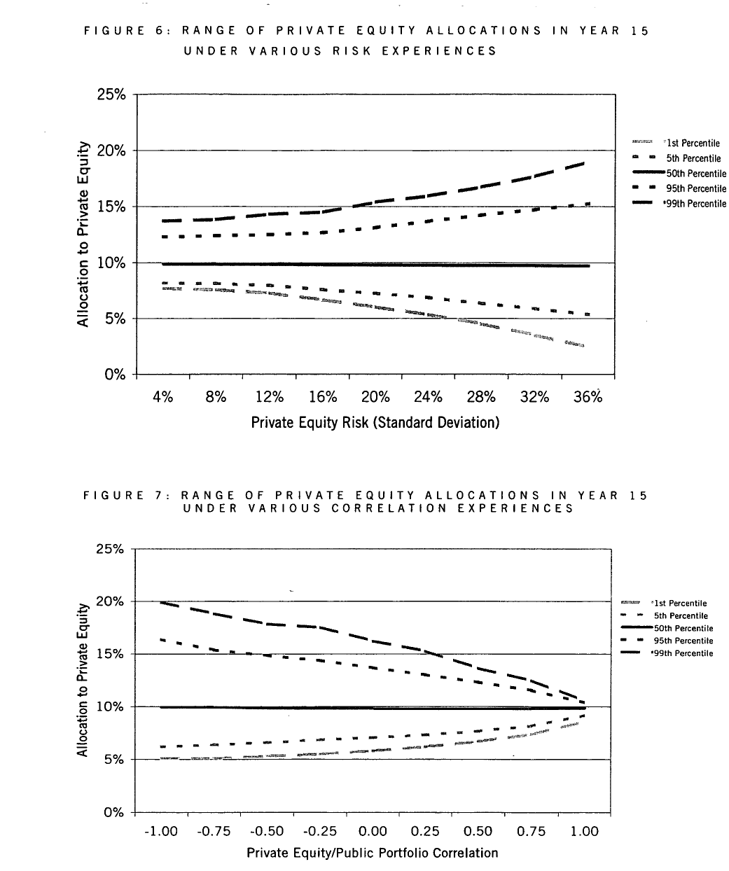

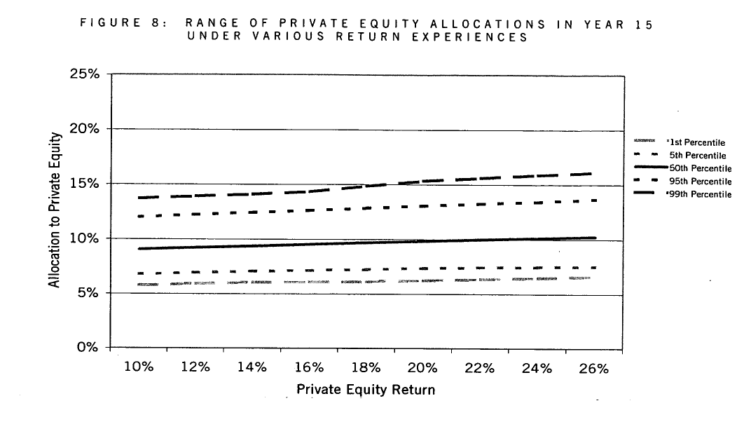

The results in FIG. 5 are subject to estimation error when investment returns do not conform to expected return, risk and correlation assumptions. To measure sensitivity to the underlying capital market assumptions, the range of outcomes was recalculated for the invested capital allocation according to different assumptions for return, risk and correlation. The range of outcomes widens when private equity risk rises, as shown in FIG. 6. The range of outcomes also widens when the correlation between the private and public market portfolios falls, as shown in FIG. 7. Neither of these results is surprising. The range of outcomes is positively related to the realized private equity return, as shown in FIG. 8, although the effect of changing the return is not as great as the effect of changing the risk and correlation assumptions.

Comparison to Other Commitment Strategies

To demonstrate the differences between the methodology of the present invention and a commonly used approach in which the annual commitment percentage is constant, two alternative strategies were tested, and the same Monte-Carlo simulation tests applied above were used. The first strategy is based on Cardie, Cattanach, and Kelly [2000], who suggest a commitment each year equal to half of the asset allocation target. Using a 10% asset allocation target, the annual commitment is 5% of the portfolio. For the second strategy, the annual commitment was lowered to 2.8% of the portfolio. Based on the cash flow and return assumptions underlying the simulations, an annual commitment of 2.8% reduces the deviations from the 10% target allocation.

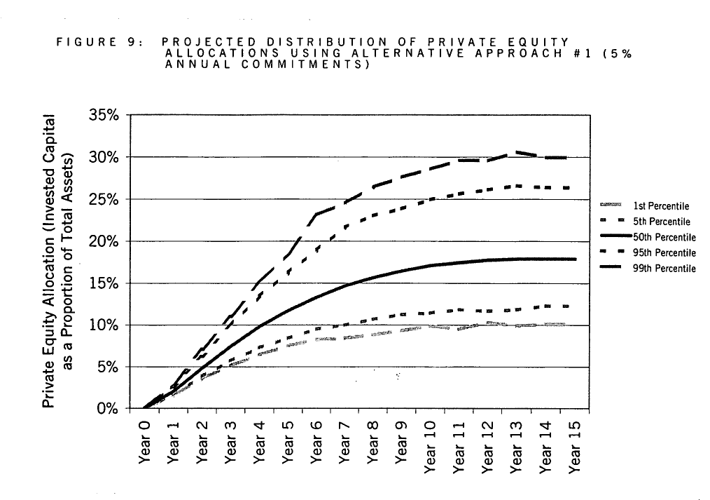

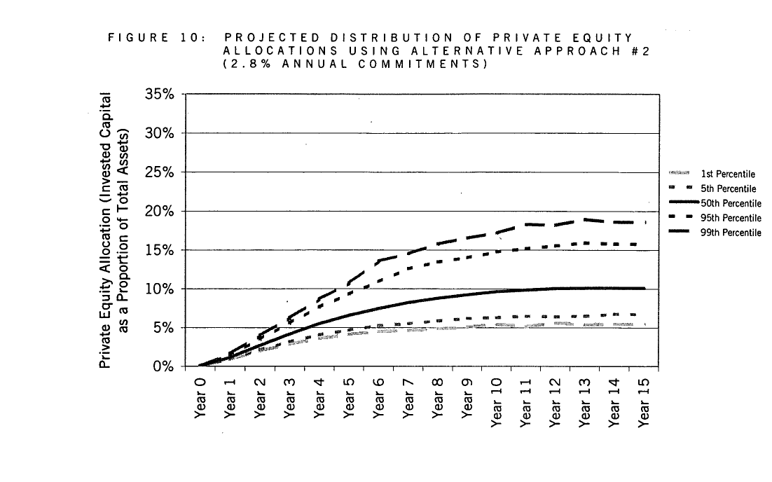

The simulation results for the first strategy are summarized in FIG. 9. These show the median invested capital allocation converging to 18%, overshooting the target by 8%. The 1st and 5th percentiles overshoot more dramatically, leaving the invested capital allocation between two and three times its target. Commitments appear to be too high using this strategy. Alternatively, an investor committing 5% per year could be anticipating a different pattern of cash flows and returns than those used in the simulations. In either case, FIG. 9 demonstrates the risks of the 5% constant commitment strategy.

For the second strategy that was tested, the annual commitment percentage was calibrated so that the median allocation converges to the target. The results are shown in FIG. 10. In this case, the results likely understate the potential for error. Investors applying a constant commitment percentage are unlikely to achieve a perfect match between the median allocation and the target. Nonetheless, the confidence intervals in FIG. 10 are considerably wider than those in FIG. 5, where the same tests were applied to the approach of the present invention. The 90% confidence interval is 59% larger than for the approach of the present invention (9.0% versus 5.7%). The standard deviation of the invested capital allocation, not shown in the charts, is 56% larger (2.8% versus 1.8%).

In addition to increasing dispersion around the targeted invested capital allocation, the alternative strategies are also slow to correct discrepancies. FIG. 10 shows that nine years pass before the median invested capital allocation for the second strategy rises from zero to within 1% of its target. The approach of the present invention reaches within 1% of the target in two years, as shown in FIG. 5. Tests based on different starting allocations lead to the same conclusions. From starting allocations of 5%, 15%, and 20%, Table 3 below shows that the approach of the present invention reaches the targeted allocation more quickly.

TABLE 3
NUMBER OF YEARS FOR THE MEDIAN
INVESTED CAPITAL ALLOCATION TO CONVERGE
WITHIN 1% OF TARGET

| | Recommended | Alternative | Alternative |
|---|---|---|---|
| Initial Private | Approach (17% | Strategy #1 | Strategy #2 |
| Equity | Committed Capital | (Commit 5% | (commit 2.8% |
| Allocation | Allocation) | Each Year) | each year) |
| 0% | 2 | Does Not | 9 |
| | | Converge | |
| 5% | 1 | Does Not | 6 |
| | | Converge | |
| 10% | 0 | Does Not | 0 |
| | | Converge | |
| 15% | 4 | Does Not | 12 |
| | | Converge | |
| 20% | 5 | Does Not | 13 |
| | | Converge | |

The alternative strategies have two weaknesses that are reflected in the simulations. First, they do not provide guidance on how to respond when past performance causes unexpectedly high or low invested capital allocations. Second, appropriate commitment percentages are difficult to determine. Some investors set commitment percentages by trial and error, changing their policy as they learn from experience. Others use a generic rule of thumb, rather than customizing their strategy to their own portfolio.

By comparison, the present invention automatically responds to past performance. Annual commitments are adjusted based on a comparison of total committed capital, which reflects performance, to the target for committed capital. Another advantage is that the committed capital target is derived from mathematical relationships. By using the equations set forth herein, investors can customize their strategy to their own expectations for cash flows and returns.

In summary, decisions about the amount and timing of commitments to private equity should be related to the asset allocation target for private equity, and a formula that directly converts an allocation target for invested capital to an allocation target for committed capital should be used. The allocation target for invested capital should be determined within the overall asset allocation process. The allocation target for committed capital should cause invested capital to converge to its target when expectations for investment returns and private equity cash flows are met. Once a committed capital target is calculated, decisions regarding new commitments should be made systematically. Investors should make new commitments when committed capital falls short of its target. New commitments should be delayed when committed capital exceeds its target. This systematic approach reduces the guesswork involved in the commitment decision and ensures that future commitments are adjusted based on past experience.

In one embodiment, the systematic approach of the present invention for committing capital to private equity is performed automatically on a periodic basis by software operating on a computer. After each calculation of the committed capital target, the software may either automatically make/delay future private equity capital commitments or, alternatively, the software may make recommendations about future private equity capital commitments (i.e., whether to commit further capital or delay commitments) which are then acted upon by the investor or a party acting on the investor's behalf.

Finally, it will be appreciated by those skilled in the art that changes could be made to the embodiments described above without departing from the broad inventive concept thereof. It is understood, therefore, that this invention is not limited to the particular embodiments disclosed, but is intended to cover modifications within the spirit and scope of the present invention as defined in the appended claims.

Appendix

The Target for Committed Capital

To derive the target for committed capital, three components of an investor's total portfolio are considered. These are sub-portfolios I, U, and L. Sub-portfolio I is invested in private equity. Sub-portfolio U is committed to but not yet invested in private equity. Sub-portfolio L is invested in public equity. Sub-portfolio U is contained within L. In other words, private equity commitments remain in the public markets until they are actually invested in the private markets.

The value of an investor's total portfolio (Pₜ) and total private equity commitments (Cₜ) at time t can be expressed in terms of the sub-portfolios.
Pₜ=Iₜ+Lₜ (A-1)
Cₜ=Iₜ+Uₜ (A-2)
Equation A-1 states that the portfolio consists of illiquid, private market assets and liquid, public market assets. Equation A-2 states that private equity commitments consist of illiquid, invested assets and uninvested assets. From A-1, it follows that the portfolio grows according to the rates of return (r_{I} and r_{L}) on sub-portfolios I and L.
Pₜ₊₁=Iₜ×(1+r₁)+Lₜ×(1+r_{L}) (A-3)
In addition to the return parameters r_{I} and r_{L}, three other parameters determine the growth of the sub-portfolios. These are the commitment rate (r_{CO}), the investment rate (r_{IN}), and the distribution rate (r_{DI}). Capital contained in L moves to U (although remaining part of L) according to r_{CO}, the rate of new commitments relative to the total portfolio. Capital moves from U to I according to r_{IN}, the rate of new investments relative to U. Capital moves from I to L according to r_{DI}, the rate of new distributions relative to I. This circular flow of capital is described by the following three difference equations.
Iₜ₊₁=Iₜ×(1+r_{I})+Uₜ×r_{IN}−Iₜ×r_{DI} (A-4)
Lₜ₊₁=Lₜ×(1+r_{L})−Uₜ×r_{IN}+Iₜ×r_{DI} (A-5)
Uₜ₊₁=Uₜ×(1+r_{L})−Uₜ×r_{IN}+Pₜ×r_{CO} (A-6)
Each of the parameters, r_{I}, r_{L}, r_{CO}, r_{IN} and r_{DI}, is defined as a proportion of beginning-of-period portfolio values. These parameters are assumed to be constants (this assumption is relaxed later). It is also assume d that the percentage allocation to each sub-portfolio converges asymptotically. Convergence of the sub-portfolio allocations occurs as Equations A-4 to A-6 pass through an increasing number of iterations, eventually reaching a steady-state as discussed in the last section of the Appendix. Assuming t is sufficiently large that a steady-state has been reached:

$$\frac{{I}_{t + 1}}{{P}_{t + 1}} = \frac{{I}_{t}}{{P}_{t}} \qquad ( A \text{-} 7 )$$

Rearranging Equation A-7 and substituting Equations A-3 and A-1:

$${I}_{t + 1} = \frac{{I}_{t}}{{P}_{t}} \times {P}_{t + 1} = \frac{{I}_{t}}{{P}_{t}} \times [ {I}_{t} \times ( 1 + {r}_{I} ) + {L}_{t} \times ( 1 + {r}_{L} ) ] \\ = \frac{{I}_{t}}{{P}_{t}} \times [ {I}_{t} \times ( {r}_{I} - {r}_{L} ) + {P}_{t} \times ( 1 + {r}_{L} ) ]$$

Iₜ₊₁ may be eliminated using Equation A-4.

$$\frac{{I}_{t}}{{P}_{t}} \times [ {I}_{t} \times ( {r}_{I} - {r}_{L} ) + {P}_{t} \times ( 1 + {r}_{L} ) ] = {I}_{t} \times ( 1 + {r}_{I} ) + {U}_{t} \times {r}_{IN} - {I}_{t} \times {r}_{DI}$$

Dividing both sides by Pₜ and solving for Uₜ/Pₜ.

$$\frac{{U}_{t}}{{P}_{t}} = \frac{{I}_{t}}{{P}_{t}} \times \frac{1}{{r}_{IN}} \times [ \frac{{I}_{t}}{{P}_{t}} \times ( {r}_{I} - {r}_{L} ) + {r}_{L} - {r}_{I} + {r}_{DI} ] \qquad ( A \text{-} 8 )$$

After introducing asymptotes for each sub-portfolio allocation, Equation A-2 may be restated as follows:

$${x}^{*} = {lim}_{t \to ∞} \frac{{x}_{t}}{{P}_{t}} , for x = I , L , U or C \\ {C}^{*} = {I}^{*} + {U}^{*} \qquad ( A \text{-} 2 a )$$

Applying the limit as t approaches infinity to Equation A-8 and solving for C*.

$${C}^{*} = {I}^{*} \times [ 1 + \frac{1}{{r}_{IN}} \times [ ( 1 - {I}^{*} ) \times ( {r}_{L} - {r}_{I} ) + {r}_{DI} ] ] \qquad ( A \text{-} 9 )$$

Equation A-9 provides the basis for the three-step commitment strategy of the present invention. First, the investor sets a target for I*, the allocation to illiquid assets. Second, the investor uses Equation A-9 to set a target for C*, the committed capital allocation. Third, r_{CO} is reset dynamically according to Equation A-10 below. (Note that r_{CO} is absent from Equation A-9 and can be reset without affecting C*.)

$${r}_{CO , t} = MAX ( {C}^{*} - \frac{{C}_{t}}{{P}_{t}} , 0 ) \qquad ( A \text{-} 10 )$$

The derivation can be extended to accommodate cash flows into or out of the portfolio. Introducing a constant rate of cash flow (r_{CF}), Equations A-3 and A-9 are modified as follows.

$$\begin{matrix}{P}_{t + 1} = {I}_{t} \times ( 1 + {r}_{I} ) + {L}_{t} \times ( 1 + {r}_{L} ) + {P}_{t} \times {r}_{CF} & ( A \text{-} 3 a ) \\ {C}^{*} = {I}^{*} \times [ 1 + \frac{1}{{r}_{IN}} \times [ ( 1 - {I}^{*} ) \times ( {r}_{L} - {r}_{I} ) + {r}_{DI} + {r}_{CF} ] ] & ( A \text{-} 9 a )\end{matrix}$$

Changes in r_{IN} and r_{DI} when the cash flow model underlying r_{IN} and r_{DI} is static are also allowed. A static cash flow model implies that the pattern of investments and distributions is the same for each commitment or vintage year. For example, 60% of each year's commitment may be invested in the same year and 40% in the next year. If the cash flow model is static and the previous assumptions still hold, then r_{IN} and r_{DI} converge asymptotically. Convergence occurs as the private equity investment program matures and fully diversifies across vintage years. Therefore, asymptotes can be introduced for r_{IN} and r_{DI} and Equation A-9 may be again restated as follows:

$${y}^{*} = {lim}_{t \to ∞} {y}_{t} , for y = {r}_{IN} or {r}_{DI} \\ {C}^{*} = {I}^{*} \times [ 1 + \frac{1}{{r}_{IN}^{*}} \times [ ( 1 - {I}^{*} ) \times ( {r}_{L} - {r}_{I} ) + {r}_{DI}^{*} + {r}_{CF } ] ] \qquad ( A \text{-} 9 b )$$

Steady-State Portfolio Growth

A formula for steady-state portfolio growth (g*) is shown below.

$${g}^{*} = {lim}_{t \to ∞} \frac{{P}_{t + 1} - {P}_{t}}{{P}_{t}} = {lim}_{t \to ∞} [ \frac{{I}_{t}}{{P}_{t}} \times ( 1 + {r}_{I} ) + \frac{{L}_{t}}{{P}_{t}} \times ( 1 + {r}_{L} ) - 1 ] = {I}^{*} \times ( 1 + {r}_{I} ) + {L}^{*} \times ( 1 + {r}_{L} ) - 1 \\ \qquad ( A \text{-} 11 )$$

It follows from convergence of the sub-portfolio allocations that I, U, L and C also grow at g* in the steady-state.
Steady-State Convergence

In the simulations described above, the steady-state convergence of the sub-portfolio allocations I*, U* and L* is demonstrated. Convergence can also be shown by re-specifying Equations A-4 to A-6 in continuous time as a homogenous, first order, linear system as follows:
I′=I×(r_{I}−r_{DI})+U×r_{IN} (A-12)
L′=I×r_{DI}+L×r_{L}−U×r_{IN} (A-13)
U′=I×r_{CO}+L×r_{CO}+U×(r_{L}−r_{IN}) (A-14)

Equations A-12 to A-14 can be represented by a vector (X) and a matrix of constants (A).

$$X = [ \begin{matrix}I \\ L \\ U\end{matrix} ] , A = [ \begin{matrix}{r}_{I} - {r}_{DI} & 0 & {r}_{IN} \\ {r}_{DI} & {r}_{L} & - {r}_{IN} \\ {r}_{CO} & {r}_{CO} & {r}_{L} - {r}_{IN}\end{matrix} ]$$

The general solution to the system of equations is:

$$X = {\sum }_{i = 1}^{3} {B}_{i} \times {e}^{{m}_{i} \times t} \qquad ( A \text{-} 15 )$$

Each Bᵢ is a multiple of an eigenvector of the matrix A, while each mᵢ is an eigenvalue of the matrix A. Derivations of Equation A-15 can be found in many textbooks. See, for example, Elementary Differential Equations [1969] by Boyce and DiPrima.

In the limit as t approaches infinity, the solution for X is dominated by the term associated with the largest eigenvalue. Therefore, the ratio xⱼ to xₖ, for any j and k, converges to the ratio of the j^{th} and k^{th} elements of the eigenvector associated with the largest eigenvalue. It follows that the system of the present invention reaches a steady-state, in which each of the sub-portfolios converges to a constant percentage of the total portfolio.

1. A method for committing capital to a private equity portion of an investment portfolio, wherein the investment portfolio includes the private equity portion and a liquid portion, comprising:
(a) determining a committed capital target based on an expected rate of return of the liquid portion of the portfolio, an expected rate of return of the private equity portion of the portfolio, an expected rate at which distributions are paid from the private equity portion of the portfolio, and an expected rate at which capital commitments associated with the private equity portion of the portfolio are invested;
(b) comparing an actual value of committed capital in the private equity portion of the portfolio with the committed capital target;
(c) delaying commitment of further capital in the private equity portion of the portfolio if the actual value of committed capital in the private equity portion of the portfolio exceeds the committed capital target; and
(d) committing further capital in the private equity portion of the portfolio if the actual value of committed capital in the private equity portion of the portfolio is below the committed capital target.

2. The method of claim 1, wherein step (a) further comprises determining the committed capital target in accordance with a target for invested capital in the private equity portion of the portfolio.

3. The method of claim 2, wherein the target for committed capital is determined in step (a) in accordance with the following equation:
$${C}^{*} = I * [ 1 + ( \frac{1}{{r}_{IN}} ) \times [ ( 1 - {I}^{*} ) \times ( {r}_{L} - {r}_{I} ) + {r}_{DI} ] ]$$
wherein C* corresponds to the target for committed capital, I* corresponds to the target for invested capital in the private equity portion of the portfolio, r_{L} corresponds to the expected rate of return of the liquid portion of the portfolio, r_{I} corresponds to the expected rate of return of the private equity portion of the portfolio, r_{DI} corresponds to the expected rate at which distributions are paid from the private equity portion of the portfolio, and r_{IN} corresponds to the expected rate at which capital commitments associated with the private equity portion of the portfolio are invested.

4. The method of claim 2, wherein steps (a)-(d) are repeated periodically, thereby causing a value representing actual invested capital in the private equity portion of the portfolio to converge to the target for invested capital in the private equity portion of the portfolio.

5. The method of claim 4, wherein steps (a)-(d) are repeated annually.

6. The method of claim 4, wherein at least one of the expected rate of return of the liquid portion of the portfolio, the expected rate of return of the private equity portion of the portfolio, the expected rate at which distributions are paid from the private equity portion of the portfolio, and the expected rate at which capital commitments associated with the private equity portion of the portfolio are invested, are recalculated during a subsequent iteration of step (a).

7. The method of claim 6, wherein each of the expected rate of return of the liquid portion of the portfolio, the expected rate of return of the private equity portion of the portfolio, the expected rate at which distributions are paid from the private equity portion of the portfolio, and the expected rate at which capital commitments associated with the private equity portion of the portfolio are invested, are recalculated during a subsequent iteration of step (a).

8. A system for committing capital to a private equity portion of an investment portfolio, wherein the investment portfolio includes the private equity portion and a liquid portion, comprising a computer with software that causes the computer to:
(a) determine a committed capital target based on an expected rate of return of the liquid portion of the portfolio, an expected rate of return of the private equity portion of the portfolio, an expected rate at which distributions are paid from the private equity portion of the portfolio, and an expected rate at which capital commitments associated with the private equity portion of the portfolio are invested;
(b) compare an actual value of committed capital in the private equity portion of the portfolio with the committed capital target;
(c) delay commitment of further capital in the private equity portion of the portfolio if the actual value of committed capital in the private equity portion of the portfolio exceeds the committed capital target; and
(d) commit further capital in the private equity portion of the portfolio if the actual value of committed capital in the private equity portion of the portfolio is below the committed capital target.
